(19) United States
(12) Patent Application Publication
(10) Pub. No.: US 2009/0097238 A1
(43) Pub. Date: Apr. 16, 2009

(54) Light

(76) Inventors: Charles M. Cousaine, Rindge, NH (US); Laura Peach, New Boston, NH (US)

Correspondence Address: OSRAM SYLVANIA INC, 100 ENDICOTT STREET, DANVERS, MA, 01923, US

(21) Appl. No.: 11/974,008

(22) Filed: Oct. 11, 2007

(51) Int. Cl. F21L 4/00

(52) U.S. Cl. 362/191

(57) ABSTRACT

A portable light (10) has a housing (12). The housing (12) has at least one metallic area (14) capable of attracting a magnet, a magnet (16) operatively associated with the at least one metallic area (14) via magnetic attraction, a sub-assembly (18) within the housing (12) comprised of a light source (20), a power supply (22) including at least one battery (22a) for illuminating the light source (20) and a switch (24) for connecting the power supply to the light source. A removable cover (26) is attached to the housing (12).

### TECHNICAL FIELD

The invention relates to electric lamps and particularly to portable electric lamps. More particularly the invention is concerned with portable LED lamp assemblies that are suitable for providing illumination under wall or ceiling mounted cabinets.

### BACKGROUND ART

Recent innovations in the light-supplying capabilities of light emitting diodes (LED or LEDs) has led to the introduction of small, portable LED lamps. One such lamp is shown and described in published patent application US 2006/0250789 A1 by the instant inventor and assigned to the assignee of the instant invention. The lamp described therein is comprised of a portable LED lamp assembly made from a plastic case including a base. The case encloses a power source; at lease one LED light source; and a spring driven electric switch. The light source is mechanically supported by the case to face axially toward a field to be illuminated. The switch is supported on the base, and oriented to be operated by forced contact at a switch contact between an on position and an off position by motion in the opposed axial direction. The power source, at least one LED light source and switch are electrically coupled together as a switched circuit. The lamp includes a reflector having a first contact point anchored to the case and a second contact point abutting the switch point. The reflector is resiliently deformable intermediate the first contact point and the second contact point. The reflector further includes a formed passage sized and positioned to admit the LED light source there in The light is often provided with magnet that is glued or taped to the plastic body and provided on its outer surface with a double-sided tape.

While this light source has proved to be extremely versatile and successful, the light emitted thereby is broadly distributed and the switching action has sometimes been found to be troublesome. Additionally, mounting the light has sometimes been problematical

### DISCLOSURE OF INVENTION

It is, therefore, an object of the invention to obviate the disadvantages of the prior art.

It is another object of the invention to enhance portable lighting.

These objects are accomplished, in one aspect of the invention, by a portable light comprising; a housing; said housing having at least one metallic element capable of attracting a magnet, a magnet operatively associated with said at least one metallic element via magnetic attraction, a sub-assembly within said housing comprising a light source, a power supply comprising at least one battery for illuminating said light source and a switch for connecting said power supply to said light source: and a removable cover attached to said housing. In preferred embodiments of the invention the switch is touch-activated or motion-activated and the light source is provided with a lens that provides a specifically illuminated area.

Mounting the portable light source is greatly improved because the magnet attraction occasioned by the metallic element of the housing allows the accompanying magnet to be substantially permanently mounted while allowing easy removal of the lamp. Further, the use of the metallic element in the housing provides for better heat dissipation than the previously employed plastic housings.

### BRIEF DESCRIPTION OF THE DRAWINGS

FIG. 1 is a plan view of the top of an embodiment of the invention;

FIG. 2 is a plan view of the bottom of an embodiment of the invention;

FIG. 3 is a perspective view of an embodiment of the invention;

FIG. 4 is a side elevatational view of an embodiment of the invention;

FIG. 5 is a plan view of an embodiment of the invention with a cover removed;

FIG. 6 is a partial sectional view with some parts omitted for clarity, taken along the line 6-6 of FIG. 5; and

FIG. 7 is a perspective view illustrating a use for an embodiment of the invention.

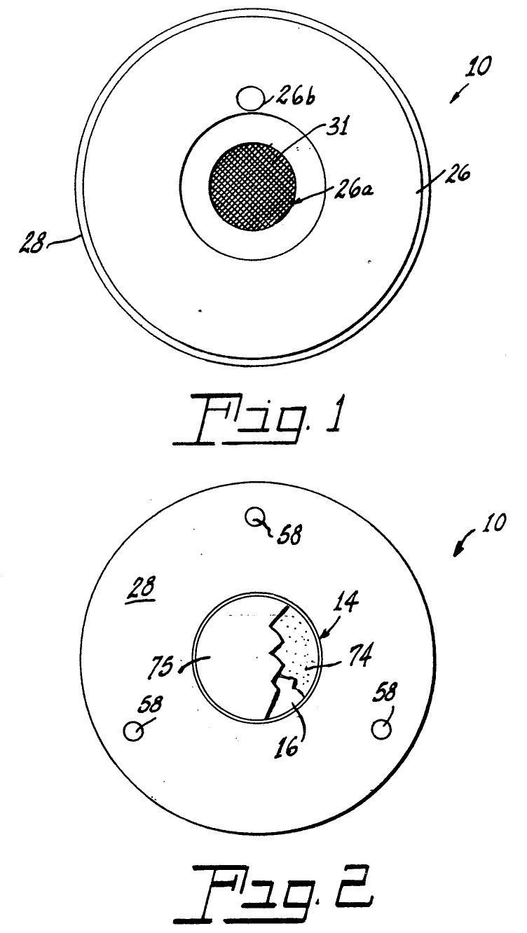

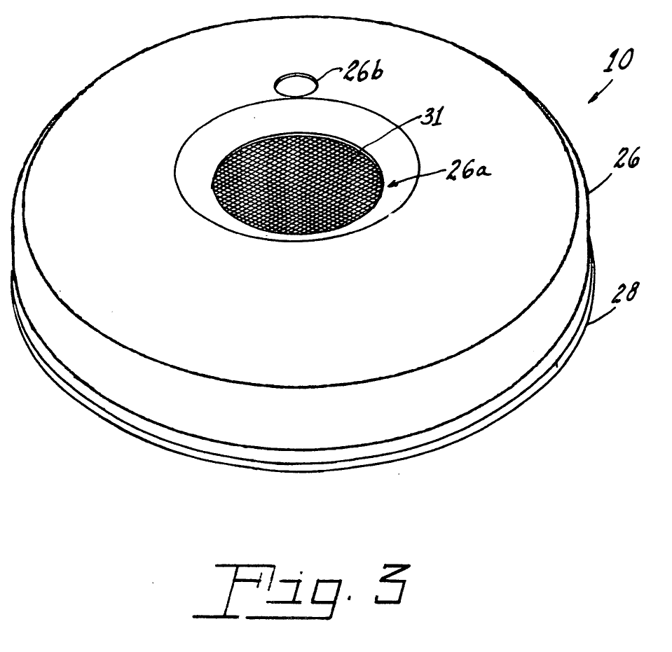

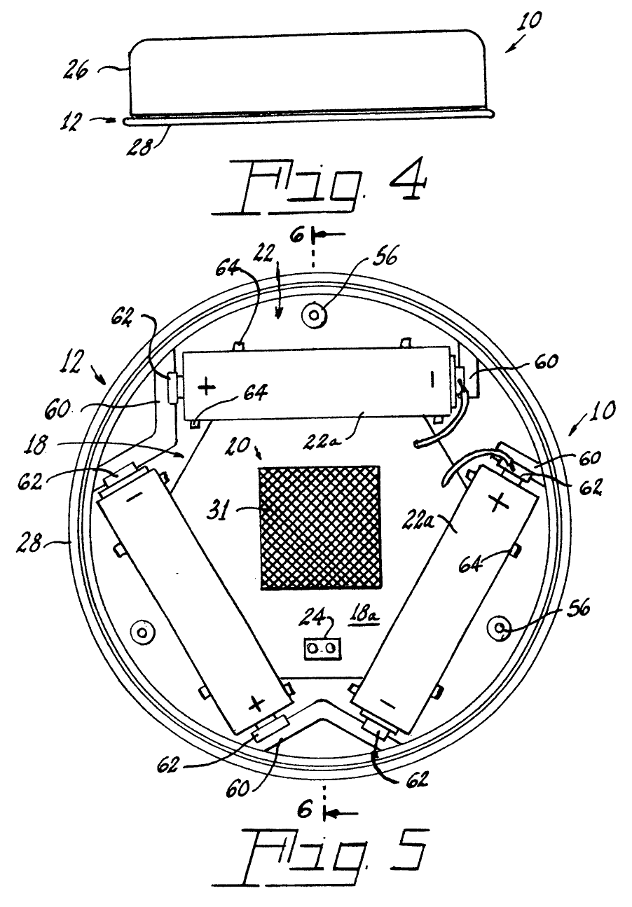

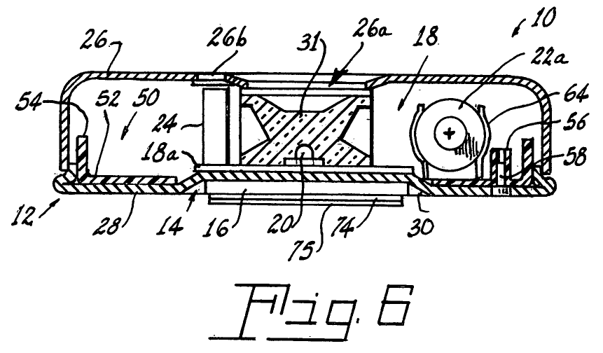

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

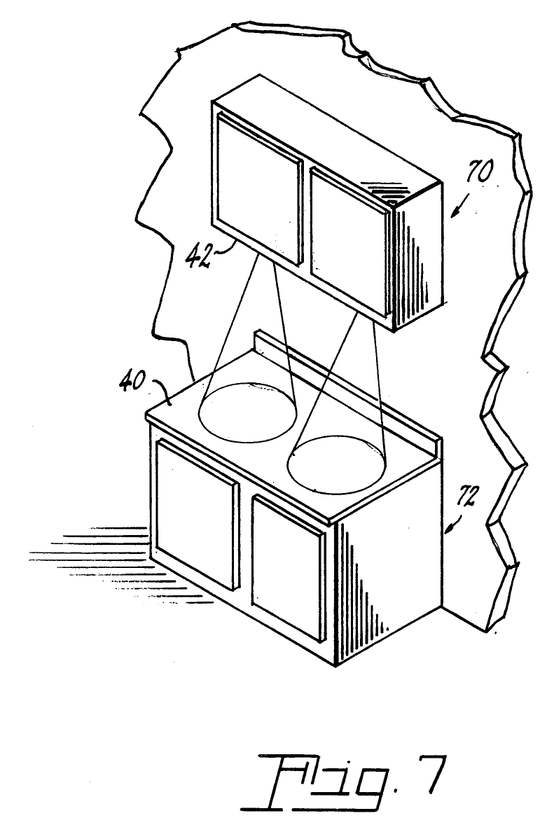

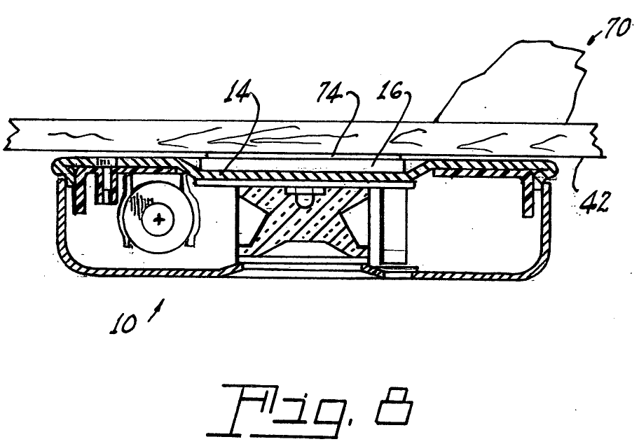

Referring now to the drawings with greater particularity, there is shown in FIGS. 5 and 6 a portable light 10 comprising a housing 12 and a removable cover 26 attached to the housing 12. The cover 26, which preferably is formed of aluminum or other rigid, light weight material, includes a substantially central opening 26a to allow the exit passage of light and an offset opening 26b to allow reception of movement by a motion-activated switch 24. The housing 12 has at least one metallic area 14 capable of attracting a magnet, a magnet 16 operatively associated with the at least one metallic area 14 via magnetic attraction, and a sub-assembly 18 within the housing 12 comprising a light source 20, a power supply 22 comprising at least one battery 22a for illuminating the light source and the switch 24 for connecting the power supply to the light source. As shown, the at least one metallic area 14 comprises the entire planar base 28 of the housing 12 and includes a depressed area 30 for receiving the magnet 16. In a preferred embodiment of the invention the entire base 28 is a magnetic material such as steel.

Preferably, the light source 20 comprises a light emitting diode that is mounted with a lens 31 that emits light in a 60 degree cone. In a preferred embodiment, the diode is an OSRAM DRAGON, available from Osram Opto Semiconductor GmbH and the lens is a Ledil Lens, available from Ledil Oy, Tehdaskatu 13, FIN-24100 SALO, Finland.

The light source 20, switch 24 and associated circuitry are carried by a printed circuit board 18a that is in fixed, intimate, heat-transferring relation with the base 28.

A plastic insert 50 with a bottom portion 52 and an upstanding wall 54 is fitted within the base 28 and is provided with bosses 56. A center opening 53 allows access to the printed circuit board 18a The insert 50 is held in place via the bosses 56 that receive retainers 58 that are fitted through base 28. The plastic insert 50 provides connector walls 60 that hold contacts 62 for the batteries 22a as well as battery clips 64 for retaining the batteries 22a The upstanding wall 54 can also be provided with cover-attaching grooves to cooperate with matching lugs formed with the cover 26 or with other types of cover-attachment.

The portable light 10 is ideally suited for under-cabinet lighting as illustrated in FIGS. 7 and 8. Therein, a wall (or ceiling) mounted cabinet 70 is positioned over a lower cabinet 72 having a first surface 40 that requires illumination. The cabinet 70 has a second surface 42 that is spaced from but facing the first surface. To provide the required illumination, the magnet 16 is affixed to the second surface 42. If the second surface is a material that is magnetic (for example, a steel cabinet) then the normal magnet attraction will be sufficient to hold the magnet 16 in position. In the event that the second surface is not magnet, the magnet 16 is provided with an adhesive layer 74 that can be employed for attachment. For shipping and transporting purposes the adhesive layer 74 can be protected by a suitable covering 75.

After the magnet 16 is fixed in position, the portable light 10 is mated to the magnet 16 via its at least one magnetic area 14.

While previous portable lights have been available with magnets for attaching the light to metal structures, the magnet was attached to the light by an adhesive that severely limited the number of times the lamp could be moved.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A portable light comprising;
a housing;
said housing having at least one metallic element capable of attracting a magnet, a magnet operatively associated with said at least one metallic element via magnetic attraction, a sub-assembly within said housing comprising a light source, a power supply comprising at least one battery for illuminating said light source and a switch for connecting said power supply to said light source: and
a removable cover attached to said housing.

2. The portable light of claim 1 wherein said at least one metallic element comprises a planar base of said housing.

3. The portable light of claim 2 wherein said planar base includes a depressed area for receiving said magnet.

4. The portable light of claim 1 wherein said light source comprises a light emitting diode.

5. The portable light of claim 1 wherein said light source employs a lens emitting light in a 60 degree cone.

6. The light source of claim 1 wherein said switch is motion-activated.

7. In a method of illuminating a first surface, the steps comprising:
affixing a magnet to a second surface spaced from said first surface and substantially facing said first surface;
affixing a portable light to said magnet via magnetic attraction, said
portable light comprising;
a housing;
said housing having at least one metallic element capable of attracting said magnet, a sub-assembly within said housing comprising a light source, a power supply comprising at least one battery for illuminating said light source and a switch for connecting said power supply to said light source: and a removable cover attached to said housing; and
actuating said switch to energize said light source and illuminate said first surface.

8. In a method of illuminating a first surface, the steps comprising:
affixing a magnet to a second surface spaced from said first surface and substantially facing said first surface; and
affixing a portable light to said magnet via magnetic attraction.
